(19) United States
(12) Patent Application Publication
(10) Pub. No.: US 2026/0216969 A1
(43) Pub. Date: Jul. 30, 2026

(54) RAPID MANUFACTURING OF COMPOSITE STRUCTURES USING FILAMENT WINDING TECHNIQUES

(71) Applicant: COLORADO STATE UNIVERSITY RESEARCH FOUNDATION, Fort Collins, CO (US)

(72) Inventor: Mostafa Yourdkhani, Fort Collins, CO (US)

(21) Appl. No.: 19/144,723

(22) PCT Filed: Jan. 3, 2024
(86) PCT No.: PCT/US2024/010114

§ 371 Date: Jun. 30, 2025

Related U.S. Application Data
(60) Provisional application No. 63/437,012, filed on Jan. 4, 2023.

(51) Int. Cl. B29C 70/32; B29C 35/08

(52) U.S. Cl. CPC B29C 70/32; B29C 35/0805

(57) ABSTRACT

Various implementations include a filament winding system. The system includes a mandrel, a motor, and an energy source. The mandrel has a rotational axis. The mandrel has an outer surface extending circumferentially around the rotational axis. The motor is for causing the mandrel to rotate about the rotation axis. The energy source is for directing energy toward a fiber wound around the outer surface of the mandrel.

### BACKGROUND

Filament winding is one of the main manufacturing techniques for fabrication of axisymmetric composite structures such as pressure vessels and tanks, tubes, pipes, shafts, and wheels. In filament winding, fiber reinforcements impregnated with resin are first wound on a rotating mandrel. The wound fiber is then vacuum bagged and transferred to an oven/autoclave for thermal curing of the composite material during long cure cycles (>4 hours of heating).

The current approaches for filament winding of composite structures typically rely on two steps: winding step on the mandrel and bagging and curing in an oven or autoclave. The traditional manufacturing approach is slow, energy-intensive, labor-intensive, and requires expensive ovens or autoclaves.

Thus, there is a need for a filament winding system that is faster, more energy efficient, and requires less labor and cost to operate.

### SUMMARY

Various implementations include a filament winding system. The system includes a mandrel, a motor, and an energy source. The mandrel has a rotational axis. The mandrel has an outer surface extending circumferentially around the rotational axis. The motor is for causing the mandrel to rotate about the rotation axis. The energy source is for directing energy toward a fiber wound around the outer surface of the mandrel.

In some implementations, the energy source is disposed within the mandrel. In some implementations, the energy source is disposed externally to the mandrel. In some implementations, the energy source is a first energy source. The system further includes a second energy source disposed within the mandrel.

In some implementations, the energy is radiative heating. In some implementations, the energy is infrared energy. In some implementations, the energy source is a resistive heater. In some implementations, the energy source is a plasma heater. In some implementations, the energy source is a microwave heater. In some implementations, the energy source is a radio-frequency heater. In some implementations, the energy is photothermal energy. In some implementations, the energy is electromagnetic energy. In some implementations, the electromagnetic energy is infrared light, visible light or ultraviolet light.

In some implementations, the system further includes a filament feeder source spaced apart from the outer surface of the mandrel. The filament feeder is configured to feed fiber onto the outer surface of the mandrel as the mandrel rotates about the rotational axis.

In some implementations, the fiber is carbon fiber. In some implementations, the fiber is glass fiber. In some implementations, the fiber is aramid fiber. In some implementations, the fiber is basalt fiber. In some implementations, the fiber is a hybrid of carbon and/or glass.

In some implementations, the system further includes a resin source for impregnating the fiber fed from the filament feeder with a resin prior to the fiber being wound onto the outer surface of the mandrel.

In some implementations, the resin includes a thermoresponsive resin. In some implementations, the resin includes a frontal polymerization resin. In some implementations, the resin includes an epoxy resin. In some implementations, the resin includes a cyclic olefin resin. In some implementations, the resin includes a vinyl ester resin. In some implementations, the resin includes a polyurethane resin. In some implementations, the resin includes a vitrimer resin.

In some implementations, the resin includes an in-situ polymerizable thermoplastic. In some implementations, the resin includes a polyacrylate resin. In some implementations, the resin includes a poly(meth)acrylate resin. In some implementations, the resin includes a polyamide resin.

In some implementations, the resin includes carbon nanotubes. In some implementations, the resin includes carbon nanofibers. In some implementations, the resin includes graphene. In some implementations, the resin includes a ceramic, for example a nanoclay. In some implementations, the resin includes metal nanoparticles.

Various other implementations include a method of forming an axisymmetric or hollow composite structure. The method includes providing a filament winding system according to implementations disclosed herein, actuating the motor to cause the mandrel to rotate about the rotational axis, causing a fiber to be fed onto the outer surface of the mandrel as the mandrel rotates about the rotation axis, causing the fiber to be impregnated with a resin, and causing the energy source to direct energy toward the resin-impregnated fiber that has been wound onto the outer surface of the mandrel to cause the resin to cure into an axisymmetric or hollow composite structure while disposed on the outer surface of the mandrel.

In some implementations, causing the energy source to direct energy toward the resin-impregnated fiber that has been wound onto the outer surface of the mandrel occurs contemporaneously with causing the fiber to be fed onto the outer surface of the mandrel as the mandrel rotates about the rotation axis.

In some implementations, causing the energy source to direct energy toward the resin-impregnated fiber that has been wound onto the outer surface of the mandrel occurs after causing the fiber to be fed onto the outer surface of the mandrel as the mandrel rotates about the rotation axis. In some implementations, causing the energy source to direct energy toward the resin-impregnated fiber that has been wound onto the outer surface of the mandrel occurs contemporaneously with and after causing the fiber to be fed onto the outer surface of the mandrel as the mandrel rotates about the rotation axis.

In some implementations, the energy source is disposed within the mandrel. In some implementations, the energy source is disposed external to the mandrel.

In some implementations, the energy source is a first energy source. The method further includes a second energy source disposed within the mandrel. The method further includes causing the second energy source to direct energy toward the resin-impregnated fiber that has been wound onto the outer surface of the mandrel.

In some implementations, the energy is radiative heating. In some implementations, the energy is infrared energy. In some implementations, the energy source is a resistive heater. In some implementations, the energy source is a plasma heater. In some implementations, the energy source is a microwave heater. In some implementations, the energy source is a radio-frequency heater. In some implementations, the energy is photothermal energy. In some implementations, the energy is electromagnetic energy. In some implementations, the electromagnetic energy is infrared light, visible light or ultraviolet light.

In some implementations, the system further includes a filament feeder source spaced apart from the outer surface of the mandrel. The filament feeder is actuated to cause the fiber to be fed from the filament feeder onto the outer surface of the mandrel as the mandrel rotates about the rotation axis.

In some implementations, the fiber is carbon fiber. In some implementations, the fiber is glass fiber. In some implementations, the fiber is aramid fiber. In some implementations, the fiber is basalt fiber.

In some implementations, causing a fiber to be fed onto the outer surface of the mandrel as the mandrel rotates about the rotation axis occurs after causing the fiber to be impregnated with a resin.

In some implementations, the system further includes a resin source for impregnating the fiber fed from the filament feeder with the resin prior to the fiber being wound onto the outer surface of the mandrel.

In some implementations, causing a fiber to be fed onto the outer surface of the mandrel as the mandrel rotates about the rotation axis occurs before causing the fiber to be impregnated with a resin. The method further includes, after causing a fiber to be fed onto the outer surface of the mandrel as the mandrel rotates about the rotation axis, disposing the wound fiber within an enclosure. The method further includes causing the fiber to be impregnated with a resin and causing the resin to flow into the enclosure.

In some implementations, the resin includes a thermoresponsive resin. In some implementations, the resin includes a frontal polymerization resin. In some implementations, the resin includes an epoxy resin. In some implementations, the resin includes a cyclic olefin resin. In some implementations, the resin includes a vinyl ester resin. In some implementations, the resin includes a polyurethane resin. In some implementations, the resin includes a vitrimer resin.

In some implementations, the resin includes an in-situ polymerizable thermoplastic. In some implementations, the resin includes a polyacrylate resin. In some implementations, the resin includes a poly(meth)acrylate resin. In some implementations, the resin includes a polyamide resin.

In some implementations the resin includes carbon nanotubes. In some implementations, the resin includes carbon nanofibers. In some implementations, the resin includes graphene. In some implementations, the resin includes a ceramic for example a nanoclay. In some implementations, the resin includes metal nanoparticles.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1A is a perspective view of the filament winding system, according to one implementation.

FIG. 1B is a perspective view of the filament winding system of FIG. 1A.

FIG. 1C is a perspective view of the filament winding system of FIG. 1A.

FIG. 2 is a cross-sectional view of a portion of the filament winding system along section line 2-2.

FIG. 3 is a side view of a mandrel of a filament winding system, according to another implementation.

FIG. 4A is an image of finished wound composite structures, according to one implementation.

FIG. 4B is an image of a finished wound composite structure, according to another implementation.

### DETAILED DESCRIPTION

The devices, systems, and methods disclosed herein provide for a new approach for one-step winding and curing of composite structures at a fraction of time compared to traditional materials and processes. In the devices, systems, and methods disclosed herein, a thermoresponsive resin system is used as the matrix resin of composites that has a long working time (>2 hours) but can rapidly cure in response to a thermal stimulus. Upon winding of fibers impregnated with the resin, heat is provided to the material using an infrared heating source located next to the mandrel and/or a resistive heater embedded inside the mandrel. The supplied heat can cure the material as it is being wound or after the winding process is complete. As a result, composite structures can be cured on the mandrel within a few minutes (1 to 15 minutes depending on the thickness of the structure) without using an oven or autoclave, thus eliminating the extra steps for bagging and long-cycle curing of composite structures.

This manufacturing approach has been used to demonstrate rapid curing (less than 2 minutes) of composite cylinders (tubes) with a diameter of about 3 cm and a thickness of about 2 mm using both external infrared heaters placed 30 cm away from the mandrel and resistive heater films placed inside the mandrel. Heat is supplied (using either or both heating sources) during the winding process to cure the material layer-by-layer or following the completion of the winding process to cure the material in bulk format. Following the cure process, the composite structures is fully cured, eliminating the need for any post-curing step.

Alternative heating approaches are also used in the devices, systems, and methods disclosed herein to rapidly cure the composite structure during or after the winding process including plasma heating, microwave heating, radio-frequency heating, and photothermal energy conversion using visible or ultraviolet lights. Additionally, in some implementations, the winding step is performed using dry fiber reinforcements (to rapidly wind the fibers), then the wound fibers are vacuum bagged and resin is infused based on common vacuum infusion processes. Upon infusion, the composite is cured using any of the above remote heating methods. This process can be applied to various types of fiber reinforcements (carbon, glass, aramid (Kevlar), basalt fibers) and rapid curable resin systems (thermosets such as epoxies, cyclic olefins, vinyl esters, polyurethanes, vitrimers; in-situ polymerizable thermoplastics such as polyacrylates, poly(meth)acrylates, polyamides). Resins can also include various fillers and reinforcements (nanoparticles such as carbon nanotubes, carbon nanofibers, graphene, nanoclay, metal nanoparticles) for improving the cure behavior and/or mechanical and functional properties of composites.

The developed manufacturing technique significantly reduces the cure time of composite structures from several hours down to a few minutes. For example, a composite structure can be cured in 1 minute, 2 minutes, 3 minutes, 4 minutes, or 5 minutes or more, based on the thickness of the composite structure being cured. For a relatively thick part having a wall thickness of around 6-8 mm, it takes around 5 minutes to cure (excluding the winding time). If the thickness increases, the cure time can also increase, but even for thicker parts the devices, systems, and methods disclosed herein can fully cure the composite structure in less than 30 minutes.

It also reduces manufacturing energy by up to four orders of magnitude (>10,000 times). By eliminating the use of bagging consumables and ovens/autoclaves, as well as reducing labor costs associated with bagging and transferring the layup to external heating sources, the cost is reduced. Another advantage is potential weight reduction due to the lower density of the polymer used in composites (10% less density) which can reduce the weight of composite structures by 5-10%. At the same time, the high fracture toughness (3 times higher than epoxies) and modulus and strengths of composites allow for designing lighter composite structures by avoiding over-design of structures which is currently practiced by composite designers/manufacturers.

Various implementations include a filament winding system. The system includes a mandrel, a motor, and an energy source. The mandrel has a rotational axis. The mandrel has an outer surface extending circumferentially around the rotational axis. The motor is for causing the mandrel to rotate about the rotation axis. The energy source is for directing energy toward a fiber wound around the outer surface of the mandrel.

Various other implementations include a method of forming an axisymmetric or hollow composite structure. The method includes providing a filament winding system, according to implementations disclosed here, actuating the motor to cause the mandrel to rotate about the rotational axis, causing a fiber to be fed onto the outer surface of the mandrel as the mandrel rotates about the rotation axis, causing the fiber to be impregnated with a resin, and causing the energy source to direct energy toward the resin-impregnated fiber that has been wound onto the outer surface of the mandrel to cause the resin to cure into an axisymmetric or hollow composite structure while disposed on the outer surface of the mandrel.

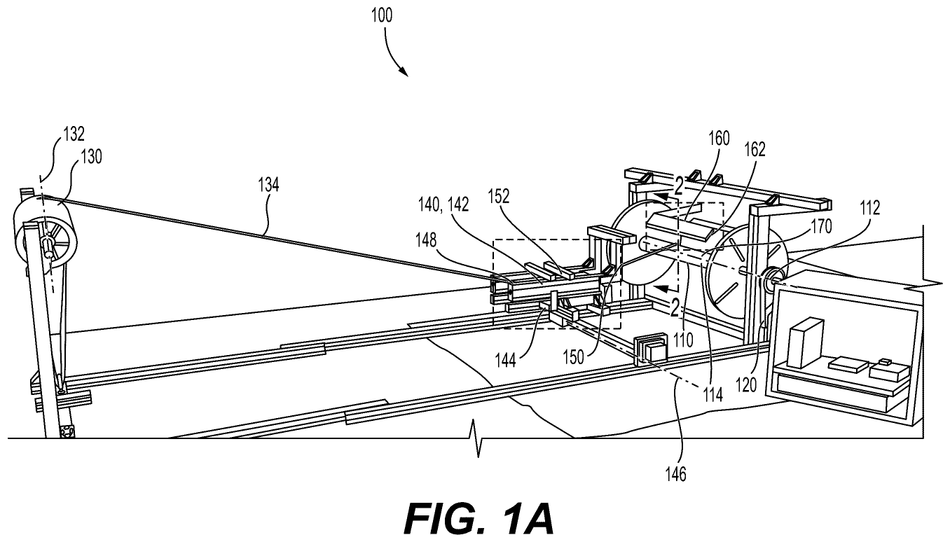

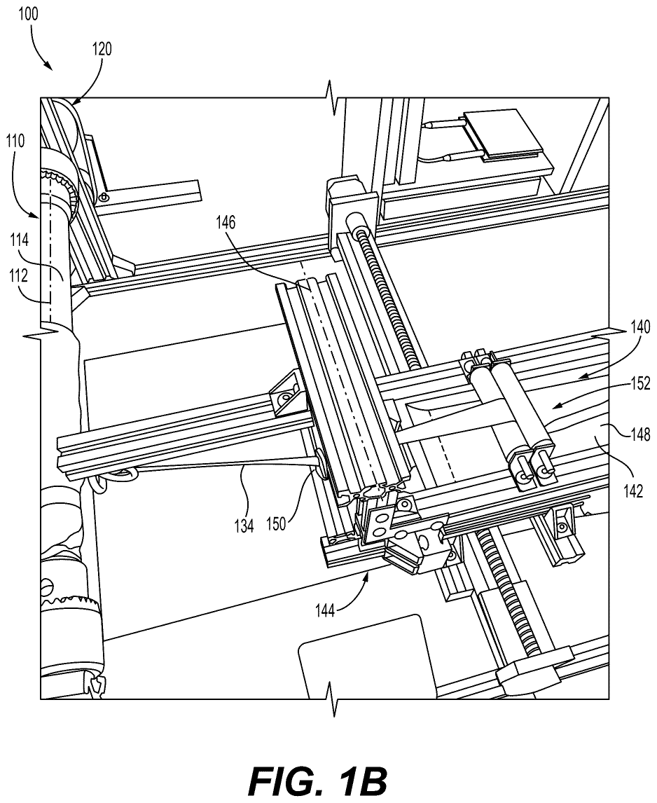

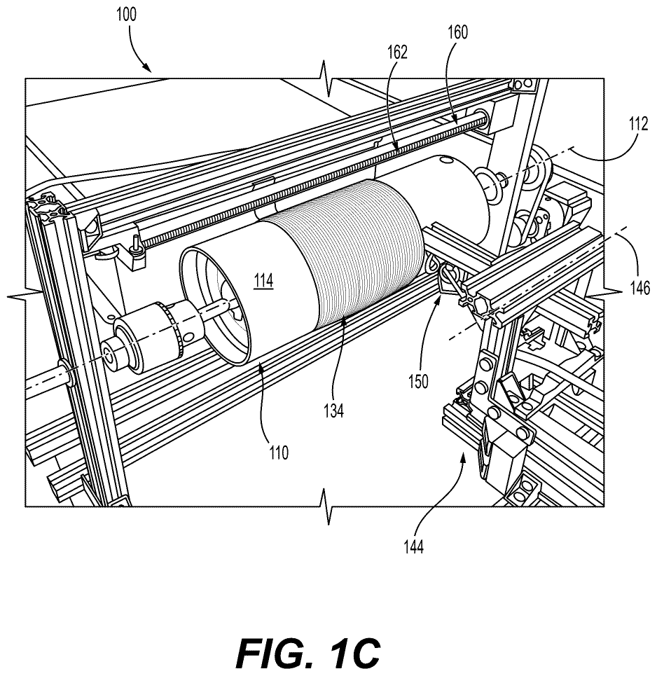

FIGS. 1A-1C show a filament winding system 100 according to one implementation. The system includes a mandrel 110, a motor 120, a filament feeder source 130, a resin source 140, and energy sources 160, 170.

The mandrel 110 includes a rotational axis 112 and an outer surface 114 extending circumferentially around the rotational axis 112. The mandrel 110 is tubular and has an inner surface 116 and an outer surface 114 radially opposite and spaced apart from the inner surface 116. During use, fiber 134 is wound around the outer surface 114 of the mandrel 110 such that the outer surface 114 of the mandrel 110 defines the inner shape of the finished product.

The motor 120 is configured to cause the mandrel 110 to rotate about the rotational axis 112. The rotation of the mandrel 110 by the motor 120 causes the fiber 134 to be wound around the outer surface 114 of the mandrel 110. Although FIGS. 1A-1C show a motor 120, in some implementations, the system includes any other device capable of, or configured to, cause rotation of the mandrel about the rotational axis.

The filament feeder source 130 is spaced apart from the outer surface 114 of the mandrel 110. The filament feeder 130 provides a bulk source of fiber 134. The filament feeder source 130 is configured to feed fiber 134 onto the outer surface 114 of the mandrel 110 as the mandrel 110 rotates about the rotational axis 112. In FIGS. 1A-1C, the filament feeder source 130 is a spool of fiber which rotates about a second rotational axis 132 as the fiber 134 is drawn towards the mandrel 110. In some implementations, the filament feeder is any bulk source of fiber that allows the fiber to be drawn from the filament feeder towards the mandrel. The filament feeder 130 shown in FIGS. 1A-1C includes carbon fibers for feeding onto the outer surface 114 of the mandrel 110, but in some implementations, the fiber is glass fiber, aramid fiber, basalt fiber, or any other fiber capable of being impregnated by a resin.

The resin source 140 is configured to impregnate and/or coat the fiber 134 fed from the filament feeder 130 towards the mandrel 110 with a resin 142. In FIGS. 1A-1C, the resin source 140 includes a chassis 144 on which the resin source 140 sits. As the fiber 134 wraps around the mandrel 110, the chassis 144 and resin source 140 translate back-and-forth with the fiber 134. The chassis 144 causes the fiber 134 to wrap around the mandrel 110 in a longitudinal direction of the mandrel 110 while the fiber 134 wraps around the mandrel 110 circumferentially. That is, the fiber 134 is made to move across the mandrel 110 such that the fiber 134 will not wrap around a single point if so desired. The chassis 144 in FIGS. 1A-1C is movable along an axis 146 that is parallel to the rotational axis 112 of the mandrel 110, however in some implementations, the chassis moves in a different direction or multiple directions at once. The resin source 140 includes input 148 and an output 150 through which the fiber 134 is drawn. The resin source 140 includes an impregnation zone 152 in which the fiber 134 is impregnated with resin 142 as the fiber 134 passes through the impregnation zone 152 towards the mandrel 110.

In the implementation shown in FIGS. 1A-1C, the resin 142 is dicyclopentadiene mixed with second generation Grubbs'catalyst and inhibitors. In other implementations, specific agents and concentrations can be changed to tune the reactivity of the resin. In some implementations, the resin includes dicyclopentadiene, other co-monomers, ruthenium catalysts, and/or inhibitors.

In the implementation shown in FIGS. 1A-1C, the resin 142 is a frontal polymerization resin (a resin that can be polymerized using a frontal polymerization strategy). Frontal polymerization refers to a self-sustaining polymerization process wherein an energy input (for example heat or irradiation) is applied to a portion of a resin to initiate an exothermic polymerization reaction. The released energy then propagates throughout the resin, continuing the polymerization reaction and creating a “front” of polymerization. Once the winding is complete, one or more energy sources 160, 170 can be used to cause frontal polymerization to be triggered such that the reaction will travel through the thickness of the part (i.e., radially with respect to the rotational axis 112 of the mandrel 110).

In some implementations, the resin can include an epoxy resin (for example diglycidyl ethers), a cyclic olefin resin (for example dicyclopentadiene), a vinyl resin (for example a vinyl ester resin including (meth)acrylate resins), a polyurethane resin (for example a one-part polyurethane resin or two-part polyurethane resin), or a polyamide. In some implementations, the resin is a vitrimer or an in-situ polymerizable thermoplastic. Although a frontal polymerization resin is shown in FIGS. 1A-1C, in some implementations, the resin is polymerized using other techniques, such as radical polymerization and condensation polymerization. In some implementations, the resin is any thermoresponsive, flash-curable, or rapid-curable resin.

In some implementations, the resin is a polyacrylate. In some implementations, the resin is a poly(meth)acrylate. As used herein, the term “poly(meth)acrylate” refers to a class of polymers derived from esters of acrylic acid, methacrylic acid, or a combination thereof. The same convention is used with reference to poly(meth)acrylamide. A (meth)acrylate resin refers to a (meth)acrylate monomer (or mixture of monomers) which can undergo a polymerization reaction. An exemplary vinyl ester resin is propane-2,2-diyl-bis[4,1-phenyleneoxy(2-hydroxypropane-3,1-diyl)]bis(2-methylprop-2-enoate), which is also a (meth)acrylate resin and is conventionally known as Bis-GMA.

As used herein, the term “vitrimer” refers to a crosslinked polymer network wherein at least a portion of the chemical bonds constituting the network are rearrangeable at elevated temperature such that the vitrimer behaves like a viscoelastic liquid, while at lower temperature the vitrimer behaves like a thermoset.

In some implementations, the resin can include one or more fillers or reinforcements, including nanoparticles such as carbon nanofibers, carbon nanotubes, graphene, nanoclay, metal nanoparticles, or any other type of particles. In some implementations, the resin does not include any fillers or reinforcements. In some implementations, the resin includes one or more volatile solvents. In some implementations, the volatile solvent is a liquid that has a boiling point (at 1 atm) that is no more than 110° C., no more than 100° C., no more than 80° C., no more than 70° C., no more than 60° C., no more than 50° C., or no more than 40° C. In other implementations the resin is provided as a neat monomer liquid, i.e., no solvent. In some implementations, the volatile solvent includes one or more of water, acetone, methanol, ethanol, 1-propanol, 2-propanol, diacetone alcohol, n-butanol, 2-butoxyethanol, propyl acetate, isobutyl acetate, n-butyl acetate, propylene glycol monomethyl ether, propylene glycol monomethyl ether acetate, ethylene glycol monobutyl ether, dipropylene glycol monomethyl ether, ethylene glycol, hexane, ethyl benzene, xylene, toluene, dimethyl sulfoxide (DMSO), dimethyl acetamide (DMAC), dimethyl formamide (DMF), dichloromethane (DCM), methyl ethyl ketone (MEK), methyl n-amyl ketone (MAK), monomethyl glycol, 1-methoxy,2-propanol, methoxy acetone, methyl isobutyl ketone (MIBK), ethyl acetate, tetrahydrofuran (THF), N-methyl-2-pyrrolidone (NMP).

The system 100 shown in FIGS. 1A-1C includes a first energy source 160 and a second energy source 170. Each energy source is positioned relative to the mandrel 110 such that it directs energy towards the fiber 134 being wound around the outer surface 114 of the mandrel 110.

The first energy source 160 is disposed external to the mandrel 110. The first energy source 160 includes two infrared heaters 162 and is positioned above the mandrel 110 such that the first energy source 160 provides energy via radiative heating to the outermost resin impregnated fibers 134 that are wound onto the mandrel 110.

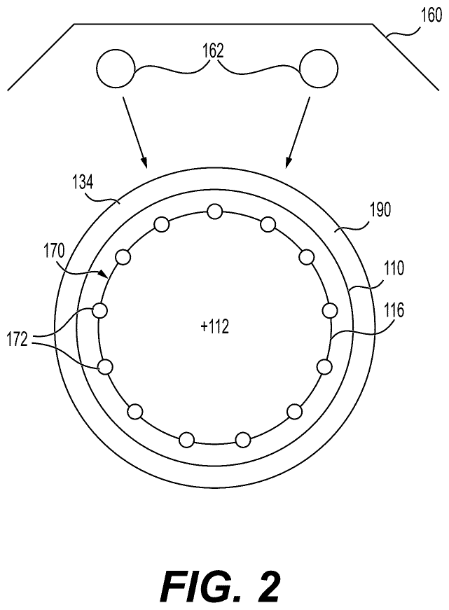

As seen in FIG. 2, the second energy source 170 is disposed within the mandrel 110. The second energy source 170 includes a plurality of resistive heaters 172 and is positioned in contact with the inner surface 116 of the mandrel 110 such that the second energy source 170 provides energy via conductive heating to the innermost resin impregnated fibers 134 that are wound onto the mandrel 110.

Although FIGS. 1A-2 show an external infrared first energy source 160 and an internal resistive second energy source 170, in some implementations, the first energy source and/or the second energy source is any form of radiative energy, photothermal energy, visible light, or ultraviolet light. In other implementations, the first and/or second energy source is a resistive heater, a plasma heater, a microwave heater, or a radio-frequency heater.

In use, an end of the fiber 134 is fixably coupled to the mandrel 110. The motor 120 is actuated to cause the mandrel 110 to rotate about the rotational axis 112. As the mandrel 110 rotates, the fiber 134 is fed from the filament feeder source 130, through the resin source 140, and onto the outer surface 114 of the mandrel 110. As fiber 134 is fed through the resin source 140, the fiber 134 is impregnated with a resin 142 such that the fiber 134 is already impregnated with resin 142 when it is wound onto the outer surface 114 of the mandrel 110.

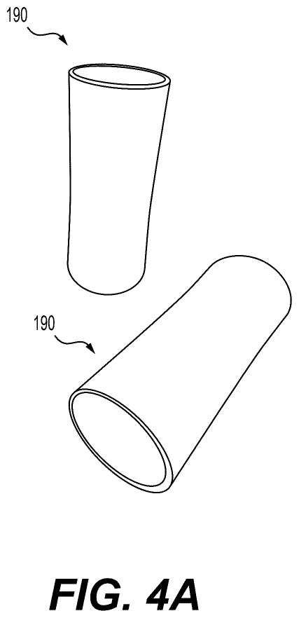

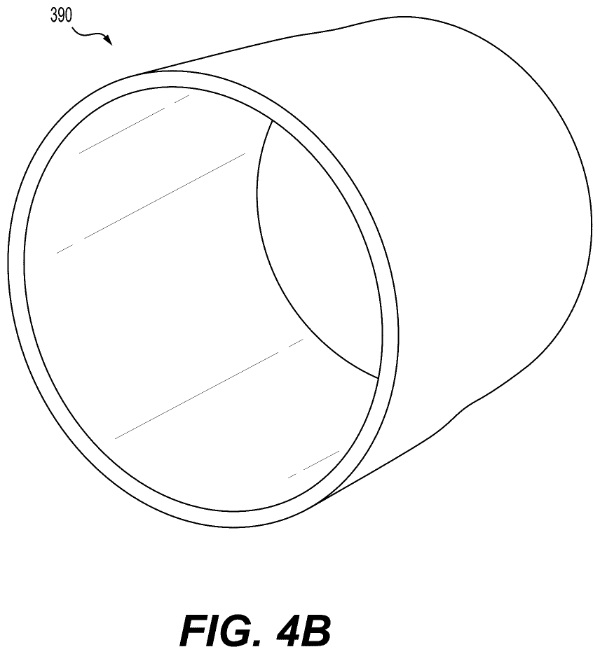

The first energy source 160 provides energy via radiative heating to the outermost resin impregnated fibers 134 that are wound onto the mandrel 110. The second energy source 170 provides energy via conductive heating to the innermost resin impregnated fibers 134 that are wound onto the mandrel 110. Both the first and second energy sources 160, 170 cause the resin impregnated fiber 134 to cure into an axisymmetric or hollow composite structure 190 while disposed on the outer surface 114 of the mandrel 110. FIG. 4A shows two examples of the axisymmetric or hollow composite structure 190. FIG. 4B shows an example of a thick walled composite structure 390.

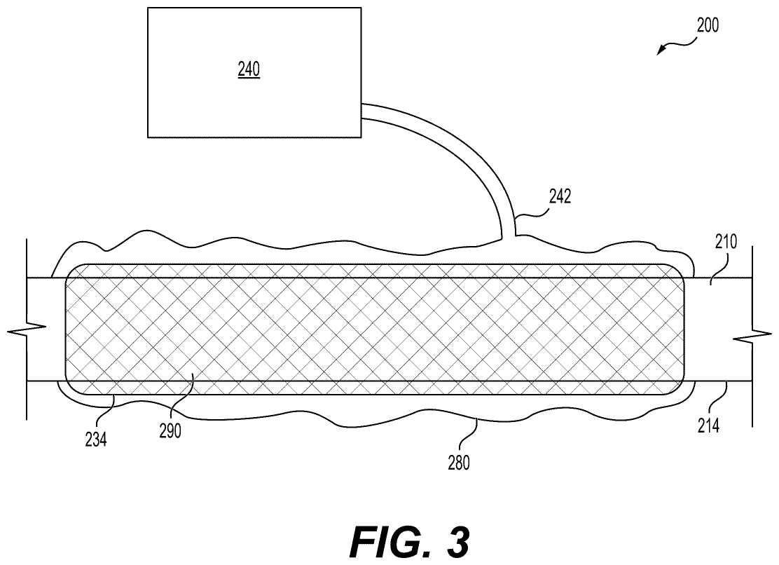

In some implementations, such as the system 200 shown in FIG. 3, the resin source 240 impregnates the fiber 234 fed from the filament feeder source with resin 242 after the fiber 234 is wound onto the outer surface 214 of the mandrel 210. FIG. 3 shows a wound fiber 234 disposed on the mandrel 210 wherein a vacuum bag 280 encloses the wound fiber 234. In FIG. 3, the vacuum bag 280 is attached to a resin source 240 such that resin 242 can be caused to flow into the vacuum bag 280 to impregnate the fiber 234. Energy from any of the energy sources disclosed herein can then be directed towards the resin-impregnated fiber 234 enclosed within the vacuum bag 280 to cause the resin 242 to cure into an axisymmetric or hollow composite structure 290.

Although the system 200 shown in FIG. 3 includes a vacuum bag 280 being used for impregnating the fiber 234 wound onto the mandrel 210, in some implementations, the enclosure is any device capable of allowing resin impregnation of the wound fiber and energy transfer to the wound fiber.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise.

The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1. A filament winding system, the system comprising:
a mandrel having a rotational axis, the mandrel having an outer surface extending circumferentially around the rotational axis;
a motor for causing the mandrel to rotate about the rotation axis; and
an energy source for directing energy toward a fiber wound around the outer surface of the mandrel.

2. The system of claim 1, wherein the energy source is disposed within the mandrel.

3. The system of claim 1, wherein the energy source is disposed externally to the mandrel.

4. The system of claim 3, wherein the energy source is a first energy source, further comprising a second energy source disposed within the mandrel.

5. The system of claim 1, wherein the energy is radiative heating.

6. The system of claim 5, wherein the energy is infrared energy.

7. The system of claim 1, wherein the energy source is a resistive heater.

8. The system of claim 1, wherein the energy source is a plasma heater, a microwave heater, a radio-frequency heater, photothermal energy, ultraviolet light, or visible light.

9-14. (canceled)

15. The system of claim 1, further comprising a filament feeder source spaced apart from the outer surface of the mandrel, wherein the filament feeder is configured to feed fiber onto the outer surface of the mandrel as the mandrel rotates about the rotational axis.

16. The system of claim 15, wherein the fiber is carbon fiber, glass fiber, aramid fiber, or basalt fiber.

17-19. (canceled)

20. The system of claim 15, further comprising a resin source for impregnating the fiber fed from the filament feeder with a resin prior to the fiber wound onto the outer surface of the mandrel.

21. The system of claim 20, wherein the resin comprises a thermoresponsive resin.

22. The system of claim 20, wherein the resin comprises a frontal polymerization resin.

23. The system of claim 20, wherein the resin comprises an epoxy resin, a cyclic olefin resin, a vinyl ester resin, a polyurethane resin, or a vitrimer resin.

24-27. (canceled)

28. The system of claim 20, wherein the resin comprises an in-situ polymerizable thermoplastic selected from the group consisting of a polyacrylate resin, a poly(meth)acrylate resin, or a polyamide resin.

29-31. (canceled)

32. The system of claim 20, wherein the resin comprises carbon nanotubes.

33. The system of claim 20, wherein the resin comprises carbon nanofibers.

34. The system of claim 20, wherein the resin comprises graphene.

35. The system of claim 20, wherein the resin comprises nanoclay.

36. The system of claim 20, wherein the resin comprises metal nanoparticles.

37-77. (canceled)
